(19) United States
(12) Patent Application Publication
(10) Pub. No.: US 2004/0098279 A1
(43) Pub. Date: May 20, 2004

(54) System of home certification and warranty

(76) Inventor: John B. Frazier, Boise, ID (US)

Correspondence Address: DYKAS, SHAVER & NIPPER, LLP, P.O. BOX 877, 802 WEST BANNOCK STREET, SUITE 405, BOISE, ID, 83701, US

(21) Appl. No.: 10/301,133

(22) Filed: Nov. 20, 2002

(51) Int. Cl. G06F 17/60

(52) U.S. Cl. 705/1

(57) ABSTRACT

A home condition analysis, repair, maintenance, certification and warranty system performed by a specialist for the owner of the home. The system includes a thorough assessment of the condition of the home and its systems; generation of a report detailing the elements of the home and their individual condition; generation of a repair and restoration report detailing the action required to restore the home to optimal condition in a graded and priced format; generation of a maintenance program for the home in a graded and priced format; submission of the report and the recommended programs to the homeowner; approval of and contract for a repair, restoration and improvement regimen; approval of and contract for a scheduled maintenance program customized for the home; performance of the repair, restoration and improvement regimen; performance of the maintenance program; enrollment in the certification program which certifies that the repairs, restoration, improvement and maintenance work has been done regularly by a qualified professional and the period for which it is done; issuance of a warranty for specific performance of specific items of the home as declared in a specific warranty.

### BACKGROUND OF THE INVENTION

Field of the Invention. The present invention generally relates to home repair and maintenance and more particularly relates to the delivery of regular and professional home repair and maintenance services, the certification that such services have been performed, and the consequent availability of a warranty of the performance of items so repaired and maintained.

### BACKGROUND INFORMATION

Owning a residential property will eventually require a considerable amount of time, training, tools and effort in order to appropriately maintain and repair the associated structures, fixtures, finishes, and appliances used therein (hereinafter “repair”). For instance, sinks drip, electrical fixtures fail, and structural problems occur regularly in any given structure. Repair, maintenance, renovation and remodeling will eventually be necessary in normal home ownership.

Homeowners have various ways of handling such “home improvement” projects. One way is by the homeowner performing the repair and maintenance himself. In such a manner, a homeowner, upon discovering a repair or maintenance need, will spend time: (1) determining how to fix it, (2) traveling to a home improvement store to purchase the requisite tools and parts, and (3) performing the repair. Provided that such a homeowner has the time, tools, and training, the homeowner is able to have the satisfaction and pride of accomplishing the work himself. However, many homeowners do not have the expertise, tools, time to research, and/or time to perform such a project, or would rather invest their time in other passions such as family, work or personal interests.

Other homeowners are inexperienced in the field of home repairs and are unable to competently perform their own repairs. Typically, such homeowners realize that they should not be performing the repair, but due to a myriad of factors, attempt to perform the repair themselves, often in the process damaging or destroying the devices and facilities attempted to be repaired.

Many homeowners are also unaware of the maintenance required to keep a home in proper working condition, to keep a home safe, and to maintain a home's value.

Oftentimes other homeowners will ignore regular maintenance that needs to be accomplished because they do not have time, tools and/or training to deal with the problem. Such a homeowner often thinks that he/she will “get around to it someday,” but someday never comes and the neglected equipment, fixture, or structure deteriorates in condition.

Additionally, many homeowners do not grasp the concept of “opportunity costs.” Opportunity costs are the costs that a person incurs for doing one action over another action because that person could be utilizing his/her time in some other way. Thus, for certain homeowners, saving the equivalent of fifteen to twenty dollars ($15.00-$20.00) an hour in performing the repairs himself/herself is offset by the income lost in taking time off work. Whereas, if the homeowner would have hired someone to undertake the process, the process would have been done quicker, more competently, and the businessperson would have been able to go to work and bill for his/her time at a much greater rate than the cost of the repair person.

Maintenance and upkeep of the systems, structures, appliances, finishes, and fixtures of a property become an important consideration when establishing the resale value of a property. If the facilities are not properly maintained, resale value is reduced. Whereas, when appropriate measures are taken to maintain the property in working order, the value of the property will likewise be maximized.

Safety and personal liability are also major concerns with respect to the maintenance and upkeep of a property. For instance, failure to properly repair a structure increases the chance that the structure will fail, potentially resulting in harm to an occupant and/or guest, as well as the incumbent liability of such an event and/or incident.

What is needed is a certifiable home repair and maintenance system whereby a service provider: (1) visits the property, (2) examines the property to determine which repairs, restorations, and improvements are needed to properly restore the property, (3) examines the property to determine the maintenance requirements of said property, (4) prepares a detailed report including recommended repairs and recommended plan of action for the repairs, (5) prepares a detailed report including required and recommended maintenance, (6) presents this report to the homeowner, this report including a repair work order and a maintenance contract delineating the pricing costs and timeline associated with such work, (7) where the owner is allowed to select which items he/she wishes to have performed, (8) the service provider or “specialist” performs or provides for the performance of the work, (9) certifying that all required repair and maintenance work has been done properly and regularly, and (10) offering a warranty which guarantees specific performance for specified items. The preferred embodiment of the present invention solves this need.

Various embodiments of the present invention include renditions on this theme. Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a system of certification of home repair and regular maintenance. The invented system is intended to be performed by a specialist for the owner of a home. This system comprises a number of steps.

In one embodiment of the present invention, the first step is performing a thorough assessment of the condition of the home and its systems (the “home physical”). This step being performed by the specialist at the request of the homeowner. Based upon the findings of the home physical, the specialist would then generate a pair of reports, namely a “repair and restoration report” and a “home maintenance prescription report.”

The repair and restoration report preferably includes the current condition of the home, the potential for HAZMAT issues (lead paint, asbestos, mold, radon, carbon monoxide, etc.), the potential for homeowner liability in view of the condition of the home, the homeowner's current insurance, and an inventory of the home's components and fixtures. Included with in the repair and restoration report is a home repair and restoration contract containing recommended repairs, renovations, and restorations (herein “repairs”) for the home.

The home maintenance prescription report preferably includes a listing of the maintenance items necessary to keep the home properly maintained. Preferably, the home maintenance prescription report includes a number of different maintenance options for the home owner to select from and contains a home maintenance contract with pricing for each of the maintenance options.

The specialist will then submit these reports (including their resulting contracts) to the homeowner for review and approval. Upon review of the reports, the homeowner will indicate to the specialist which repairs and maintenance options that the homeowner would like the specialist to provide for the performance of. The specialist would then schedule the performance of the approved repairs and maintenance option(s), and provide for the performance of said tasks. The specialist may “perform” himself, or may delegate or subcontract said task(s).

The specialist will both certify the performance of and keep a record pertaining to the repair and maintenance of the home. It is preferred that the specialist also provide a warranty that the specific systems and fixtures will remain in operable condition for a specified period of time pending having all of the repairs performed and having the customized prescribed maintenance program performed for a specified period of time.

The present invention is a comprehensive means of maintaining the safety, security and comfort of owner occupied residential property. The present invention has inherent within it the potential to certify that those characteristics of a home so maintained are in fact present when such a home is marketed and sold. If the home is marketed with a label certifying that the present invention has been implemented on the home, the value of the home will be enhanced by the assurance that it has been certified to be safe, secure and comfortable to the extent that the present invention has been implemented.

Benefits of the present invention to the homeowner include the assurance of the performance of specific home repairs and regular maintenance, the protection of the home's value through certification, risk management, and the recovery of personal time previously expended repairing and maintaining the home.

Benefits of the present invention to a potential purchaser of the home include a certification of completed care for the home including both extent and duration, the assurance of purchasing a well-maintained home, the elimination of a “home physical” normally required for continued care, the known cost of continued regular maintenance, the known history for declaration during future sale of home, the ease of and confidence in future disclosure, and the anticipated life expectancy of maintained systems & appliances.

Still other objects and advantages of the present invention will become readily apparent to those skilled in this art from the following detailed description wherein I have shown and described only the preferred embodiment of the invention, simply by way of illustration of the best mode contemplated of carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 shows a schematic diagram of the preferred embodiment of the present invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The present invention is a system to provide and certify home repair and maintenance. The system is intended to be performed by a specialist for the owner of the home. It is envisioned that the present invention will be utilized by a local contractor, service provider or network of contractors (herein “specialist”) to create and maintain a home repair, maintenance and improvement service.

The preferred embodiment of the present invention comprises a number of steps, some of which are optional.

One step is the performance of a thorough assessment of the current condition of the home and its systems. This assessment or “home physical” includes an assessment and cataloging of all significant components of the home and their respective conditions with an eye towards safety, security, value, comfort, and market appeal. Both the inside and the outside of the home are examined, particularly the electrical system, plumbing system, roofing, insulation, climate conditioning system (furnaces, air conditioners, etc.), and the home safety systems (fire alarms, carbon monoxide detectors, security alarms, etc). The home physical could also include an assessment of danger from natural forces, including ground motion (seismic), severe wind, accident, and flood danger potential.

As mentioned supra, the home physical preferably includes an examination of the shell (exterior system) of the home, including openings, the foundation, and the weather skin. For instance, the examination might include the roofing, locks, exterior paint, trim, weather stripping and caulking, external electrical fixtures, attic and crawl space ventilation, gutters and drainage, doors and windows, stairs, decking, railing, porches, etc. The home physical may also include an examination of the yard and other grounds. For instance, the home physical may include an examination of landscaping, sidewalks, driveways, pathways, fencing, hot tubs, pools, etc. The home physical may also examine the condition of adjoining property for potential hazards that may effect the condition of the homeowner's property and home, for instance: diseased trees, water run-off, etc.

The home physical also preferably includes an examination of the appliances. The term “appliance” is general, including, but not limited to the range, refrigerator, microwave, oven, deep freezer, washer, dryer, water conditioner, central vacuums, water heater, etc. Other appliances and electronic devices could also be examined.

The interior of the home is also examined during the home physical, including surfaces, finishes, and fixtures. For instance, the interior paint, interior lighting, interior flooring and floor coverings, fireplaces, ceiling fans, trim, countertops, sinks, tubs, interior doors, interior stairs, ventilation, etc.

Optionally, some repairs may be performed while the physical assessment is taking place. For instance, if a problem is found with a loose duct in the crawl-space, it may be expeditious to spend a minute or two of time to correct the problem when it is noticed rather that crawl back under the structure to perform a follow-up repair.

Optionally, a hazardous materials (HAZMAT) exam could likewise be included as part of the initial assessment or home physical. Such a HAZMAT exam would include testing and reporting for certain delineated conditions, chemicals and other hazardous materials, such as radon, asbestos, lead, mold, carbon monoxide, etc.

The results of the home assessment are then utilized by the specialist in his/her creation of a “repair and restoration report” and a “home maintenance prescription report.” These reports (the repair and restoration report and the home maintenance prescription report) are preferably to be accompanied with contracts or work orders. It is envisioned likewise that each of these two documents (report and related contract) could be combined together as the same presentation. This contract(s) may contain the terms and conditions regarding the specialist's services, including the repairs, maintenance options and pricing, or said information may be separately provided. The contract(s) will detail the home repair and/or maintenance program provided by the specialist, and will detail such information as the expected responsiveness of the specialist, as well as the scope of work to be provided by the specialist.

The repair and restoration report details the results or findings of the home physical assessment, including notations on flaws and needed, suggested, and optional repairs and improvements (collectively “repairs”) to the home. It is preferred that the repair and restoration report would further include a list or catalogue of the fixtures, appliances, and finishes present in the home. This list could then be submitted by the homeowner or the specialist on behalf of the homeowner to the homeowner's insurance underwriter as evidence of what the homeowner owns in the case of loss. A copy of this catalog would be kept by the homeowner, as well as the specialist for future reference.

Optionally, if a hazardous materials (HAZMAT) examination was performed during the home physical, this HAZMAT examination would culminate in the preparation of a portion of the repair and restoration report detailing the findings of the HAZMAT exam including a response strategy, potentially including encapsulation and/or remediation of the identified hazardous materials.

Optionally, the repair and restoration report may include a homeowner risk management assessment. Such a homeowner risk management assessment would include an analysis of the homeowner's current insurance in view of the findings of the report, preferably by an insurance professional. Ideally, the homeowner's insurance agent would offer a reduction in the homeowner's insurance premiums based upon the restored and maintained condition of the home and/or pending approval of certain parts of the homeowner's home. The insurance agent may also suggest changes in the homeowner's insurance policy coverage based upon the findings.

This home maintenance prescription report includes a minimum required maintenance regimen with suggested optional maintenance upgrades. These are collectively referred to as “maintenance options” or “maintenance levels.” It is preferred that these maintenance options be presented with pricing established for the performance of such maintenance options. For example, a first level could be created including a required regular maintenance to the systems and shell of the home. Such a level would include the pricing on negotiated or adjusted handyman fees and include a schedule of when performance of the individual repairs and maintenance would be performed. A second level might include the recommended regular maintenance of the system, shells, and appliances, including negotiated or adjusted handyman fees and scheduling. A third level might include the optimal regular maintenance of the system, shells, appliances, and interior, including negotiated or adjusted handyman fees and scheduling. A fourth level might include a concierge-style (on-call) service package. Such a concierge-style service package would make the specialist's services available to the homeowner twenty-four hours a day, seven days a week.

Another example of a home maintenance prescription report/contract could include four different maintenance options resulting in a corresponding level of certification. A first maintenance option might certify that the major systems have been monitored and maintained the preceding twelve months, including the electrical, plumbing, HVAC and fire & safety systems. This first maintenance option could also certify that the major appliances (if present) have been monitored and serviced the preceding twelve months, including, for instance, the cook top & oven, refrigerator, dishwasher, garbage disposal, washing machine & dryer, water softener and the built-in microwave.

A second maintenance option might include a corresponding certification that the exterior shell has been monitored and maintained the preceding twelve months, including (where present), for instance, the roof & guttering, exterior surface & trim, foundation & grading, ventilation, windows & doors including hardware and sealing, fencing and irrigation.

A third maintenance option might include a corresponding certification that the interior fixtures, finishes and features have been monitored and maintained the preceding twelve months, including, for instance, the lighting fixtures, the kitchen & bath fixtures, the flooring & trim, the walls, ceilings & trim, counters & cabinets, and paint & stain.

A fourth maintenance option might include a corresponding certification that the home has been verified to be checked for and either free of or declared and management implemented for lead, asbestos, radon, dangerous mold, and seismic vulnerability.

Additionally, the specialist may provide a “home refresh service” by including a list of observed worn out and outdated items which the homeowner may wish to replace.

The responsiveness of the specialist is preferably defined by contract pricing, thereby allowing the specialist to offer both normal service rates, discounted service rates and premium service rates. Discounted repair rates could be where the homeowner prepays and is willing to allow the specialist to schedule the timing of the performance of the work flexibly. Normal repair rates could be invoiced at time of service (a credit account) and scheduled as resources are available. Premium repair rates could be covered or guaranteed through retainer fees paid in the contract, thereby guarantying a 24-hour response time. Additionally, emergency service, performed for emergency service rates, could be available 24-hours a week, 7-days a week, 365 days a year.

Upon generation and preparation, these two reports, with or without a contract(s), would then be submitted to the homeowner for review and comment. At this point, the homeowner would be able to select whether he/she would like for the specialist to perform the necessary repairs and select which of the maintenance options he/she wants the specialist to perform or arrange to have performed.

The present invention includes a home repair and maintenance certification program. Under such a certification program, upon (1) completion of the repairs and renovations recommended by the specialist, (2) performance of regular maintenance, (3) both by a qualified professional service provider(s), (4) for a specified minimum period of time, the home would be certified. Appropriate paperwork would be presented to the homeowner regarding the certification and the specialist would maintain verification of the “certified” status of the home.

If the homeowner later decides to place his certified home on the market, potential purchasers would be able to confirm the “certified” status, thereby giving the potential home purchaser the peace of mind that the home being purchased was properly maintained for a specified period of time and kept in good repair. This home certification could likewise be presented to the homeowner's insurance provider for assisting in the determination of the homeowner's insurance rating. Alternatively, the certification could be utilized in the determination of the value of the home by a home appraiser or utilized in determining the marketability of the home.

Preferably, the specialist would not certify the home unless it had been both repaired as advised and professionally maintained for a prescribed period of time, for instance one year. The specialist may or may not charge additional fees to certify the house and/or to report certification status, for instance to the homeowner or a third party such as an insurance carrier.

The present invention, being a comprehensive means of maintaining the safety, security and comfort of owner-occupied residential property, has inherent within it the potential for the specialist to provide a warranty that the property's systems, fixtures and features are currently fully functional and will remain so for a specified period of time. Thus, the current owner or the purchaser of a home maintained by the present invention for a predetermined (specified) period of time can then purchase a warranty that the items will have a projected life span and that replacement is warranted and will be paid for by the specialist (or another entity) if failure occurs prior to the end of the projected time span.

By virtue of having a thorough & intimate knowledge of the home, an average life expectancy of an item can be predicted. Because the maintenance regimen and the specifications of the replacement item are known, the replacement cost and the risk that is to be taken is thus known. This knowledge enables the computation of what an appropriate fee would be to warrant that said fixture will last for a pre-defined time. This knowledge, coupled with the fact that complete failure is very unlikely, enables an assurance that the warranty fee would more than pay for repairs to keep the item working through the end of the warranty period. Considering that the repair and/or replacement of the item outside of the regular maintenance program is very unlikely, a warranty can be included in the present invention.

Alternatively, the condition of the systems, components, fixtures and the home itself could be warranted and guaranteed to remain such if the custom prescribed maintenance program is continued. Likewise, the specialist would preferably track the existing manufacturer's warranties and would work under those warranties where possible.

The specialist may also provide general home improvement services, for example, room additions, kitchen remodeling, etc. These home improvement services may likewise include component upgrades, for instance recommending a homeowner replace an old water heater with a more efficient model. These home improvement services are preferably covered under their own warranty.

The present invention could likewise include a home sale preparation program whereby the specialist would work with the real estate agent to prepare the home for sale on the market, undertaking repairs, restorations, and remodelings as directed by the owner or by the real estate agent representing the owner in order to achieve maximum salability of the home.

In an alternative rendition of the present invention, the specialist could be involved in custom new home construction for the home owner. By designing and building a brand new home for an existing client, the steps of needing a home physical/assessment and a repair and restoration report are eliminated, with the homeowner merely needing to have the home maintained to achieve certification—status. Likewise, if the homeowner purchased a new home from another builder, the specialist may or may not remove the steps of home physical/assessment depending upon the quality of the home and the reputation of the builder.

Alternatively, where a homeowner purchases a used home, the specialist would step in (upon the request of the homeowner) to provide the home physical as well as the maintenance prescription and the repair and restoration report in order for the home to be placed on a certification track.

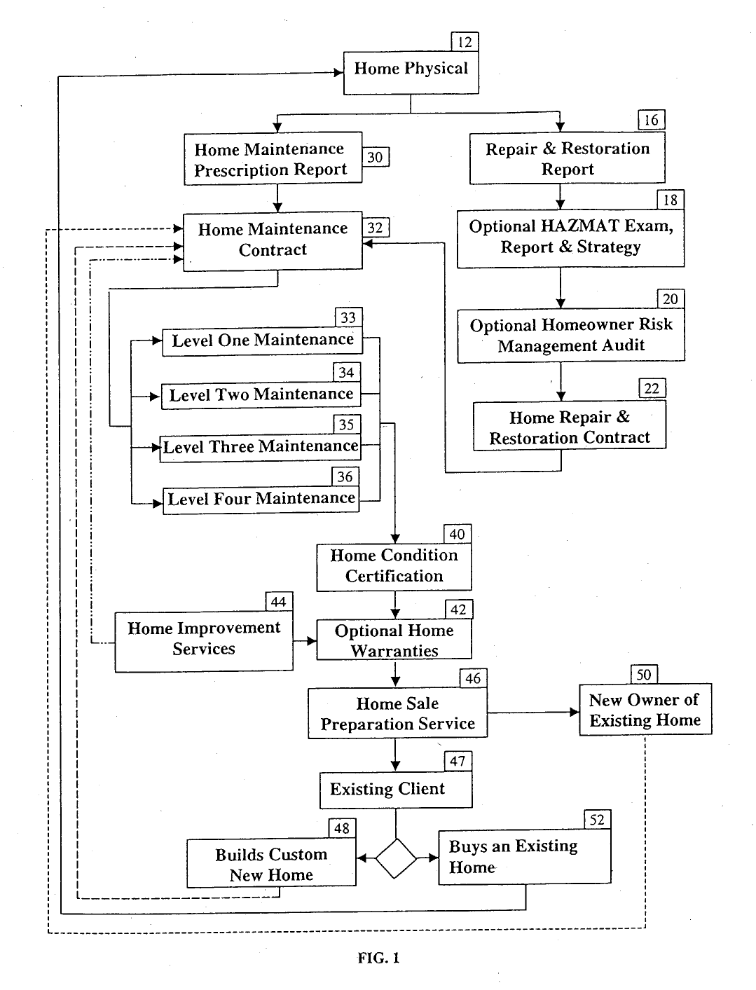

The preceding paragraphs have described the various parts of the present invention and how they operate together. The preferred embodiment of the present invention 10 is shown in FIG. 1. Referring now to FIG. 1, the homeowner hires the specialist to perform a home physical 12 for the home. The specialist generates a home physical report which contains a repair and restoration report 16 and a home maintenance prescription 30. This home physical report is then given to the homeowner.

The repair and restoration report 16 includes a thorough report of the current condition of the home, and may include an inventory of the home's components and fixtures. Optionally, the repair and restoration report 16 may include the results of a hazardous material examination 18 including a report and a strategy for responding to the presence of any hazardous material found, i.e., lead paint, asbestos, mold, radon, etc. Optionally, the repair and restoration report 16 will include a homeowner risk management audit 20, this audit being an analysis of the homeowner's “homeowner's insurance” policy in light of the condition of the home considering the needed repairs and the proposed maintenance regimen.

The repair and restoration report 16 further includes a home repair and restoration contract 22 containing an itemization of the repairs and restorations the specialist defines as necessary. These repairs and restorations are presented to the homeowner with pricing so the homeowner can hire the specialist to perform such repairs and restorations.

The home physical report also includes a home maintenance prescription report 30. The home maintenance prescription report 30 contains a custom graduated maintenance program designed for the home with pricing. This custom home maintenance program is recomposed as a home maintenance contract 32 which is then presented to the homeowner. This home maintenance contract 32 contains at least one customized maintenance level or program. The embodiment shown in FIG. 1 has four separate maintenance levels (33, 34, 35, 36). These maintenance levels or programs would be presented to the homeowner with pricing so the homeowner can hire the specialist to perform such maintenance.

Upon completion of the prescribed repairs and the necessary maintenance and renovations by the specialist, the specialist will certify the home as having home condition certification 40. Upon certification, the specialist can provide a home warranty 42 of the condition of selected systems, components and fixtures of the home. These systems, components and fixtures are warranted and guaranteed to remain such if the custom prescribed maintenance program is continued.

Additionally, after certification, certain home improvement services 44 such as upgrades, improvements, and additions may be designed and installed in the home per a request by the homeowner. These improvements would likewise be potentially warranted under the home warranty 42. Further, new home improvements via home improvement services 44 may be included within the home maintenance contract 32 (potentially through a revision to the home maintenance contract) if the homeowner so chooses.

Optionally, the specialist may provide home sale preparation services 46. Such services would be provided upon request by the home owner. These services can be directed by the homeowner and/or by the homeowner's real estate agent or other representative.

The new homeowner 50 may opt to continue utilizing the present invention 10. If that is the case, and certification has been obtained and maintained, then new homeowner could step into the invented method at the home maintenance prescription 30 step, needing to merely maintain the home in order to continue certification.

The old homeowner (existing client) 47 may opt to utilize the specialist's services and the application of the present invention in the custom design and building of a new home 48. If the existing client 47 buys an existing home 52, whether brand new or used, such a home can be worked into the invented method. For instance, if the specialist pre-qualifies the building, the builder, and/or the manner of building the old homeowner's new home, then the old homeowner could step into the invented method at the home maintenance prescription step, needing to merely maintain the new home as prescribed in order to obtain certification (because the home is new and the construction has been pre-approved, no repairs or restorations are necessary). However, if the homeowner purchases a new home that is not pre-qualified by the specialist (for instance, if the specialist is unsure of the builder's reputation for quality or other concerns), then the new home would need to start the present invention by having a home physical performed. Likewise, if the homeowner purchases a used home, the used home would need to start the present invention by having a home physical performed.

While the present invention refers to the specialist “performing” certain tasks, it is expressly envisioned that the specialist may himself perform the task, may delegate the task or may subcontract the task, etc.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A system of home repair and maintenance certification, said system performed by a specialist for the owner of a home, said system comprising the steps of:
performing a thorough assessment of the condition of the home and its systems;
generating a report detailing the results of said assessment, said report including a list of repairs that need to be performed on said home, said report further including a maintenance program for properly maintaining the condition of said home;
submitting said report to said owner;
obtaining from said owner approval to perform said repairs;
obtaining from said owner approval to begin said maintenance program;
scheduling the performance of said repairs;
scheduling the performance of said maintenance program;
performing said approved repairs;
performing said maintenance program; and
certifying that said repairs and said maintenance program have been performed upon completion of said repairs and performance of said maintenance program for a specified period of time.

2. The system of claim 1 wherein said report includes the current condition of the home.

3. The system of claim 1 wherein said report includes the potential for hazardous materials issues.

4. The system of claim 1 wherein said report includes an inventory of the house's components and fixtures.

5. The system of claim 1 wherein said report comprises at least two different maintenance options within said maintenance program, wherein said homeowner is allowed to select which maintenance option(s) said specialist will perform.

6. The system of claim 1 further comprising the step of warrantying said home and selected systems if said repairs are completed, said maintenance program is performed for a specified period of time, and said maintenance program continues to be performed.

7. A system of home repair and maintenance certification, said system performed by a specialist for the owner of a home, said system comprising the steps of:
performing a thorough assessment of the condition of the home and its systems;
generating a report detailing the results of said assessment, said report including a list of repairs that need to be performed on said home, said report further including a maintenance program for properly maintaining the condition of said home;
submitting said report to said owner;
obtaining from said owner approval to perform said repairs;
obtaining from said owner approval to begin said maintenance program;
scheduling the performance of said repairs;
scheduling the performance of said maintenance program;
performing said approved repairs;
performing said maintenance program;
certifying that said repairs and said maintenance program have been performed upon
completion of said repairs and performance of said maintenance program for a
specified period of time; and
warrantying said home and its systems if said repairs are completed, said maintenance
program is performed for a specified period of time, and said maintenance
program continues to be performed.

8. The system of claim 7 wherein said report includes the current condition of the home.

9. The system of claim 7 wherein said report includes the potential for hazardous materials issues.

10. The system of claim 7 wherein said report includes an inventory of the house's components and fixtures.

11. The system of claim 7 wherein said report comprises at least two different maintenance options within said maintenance program, wherein said homeowner is allowed to select which maintenance option(s) said specialist will perform.

12. A system of home repair and maintenance certification, said system performed by a specialist for the owner of a home, said system comprising the steps of:
performing a thorough assessment of the condition of the home and its systems, said assessment including the current condition of the home, the potential for HAZMAT issues, and an inventory of the home's components and fixtures;
generating a report detailing the results of said assessment, said report including a list of repairs that need to be performed on said home, said report further including a maintenance program for properly maintaining the condition of said home;
submitting said report to said owner;
obtaining from said owner approval to perform said repairs;
obtaining from said owner approval to begin said maintenance program;
scheduling the performance of said repairs;
scheduling the performance of said maintenance program;
performing said approved repairs;
performing said maintenance program;
certifying that said repairs and said maintenance program have been performed upon completion of said repairs and performance of said maintenance program for a specified period of time; and
warrantying said home and selected systems if said repairs are completed, said maintenance program has been performed for a specified period of time, and said maintenance program continues to be performed.

13. The system of claim 12, wherein said report includes the potential for homeowner liability in view of the condition of the home and the homeowner's current insurance.

14. The system of claim 12 wherein said report comprises at least two different maintenance options within said maintenance program, wherein said homeowner is allowed to select which maintenance option(s) said specialist will perform.
